(19) United States
(12) Patent Application Publication
(10) Pub. No.: US 2026/0354395 A1
(43) Pub. Date: Nov. 12, 2026

(54) Food Processing Line and Method for Processing Foodstuff

(71) Applicant: GEA FOOD SOLUTIONS BAKEL B.V., Bakel (NL)

(72) Inventors: Joost Van Erp, Nuenen (NL); Harrie Van Beers, Budel (NL)

(21) Appl. No.: 19/141,365

(22) PCT Filed: Nov. 29, 2023
(86) PCT No.: PCT/EP2023/083502

§ 371 Date: Jun. 20, 2025

(30) Foreign Application Priority Data
Dec. 23, 2022 (EP) 22216496.4

(51) Int. Cl. A22C 17/00; A22B 5/00

(52) U.S. Cl. CPC A22C 17/0053; A22B 5/007; A22C 17/0073

(57) ABSTRACT

Food processing line and method that includes an injection apparatus configured to inject liquid into foodstuff, at least one microwave sensor configured to sense microwave transmission data of the foodstuff, the at least one microwave sensor includes a microwave transmitter and a microwave receiver that is spaced from the microwave transmitter, the microwave receiver configured to receive a transmission signal transmitted by the microwave transmitter, and a control unit configured to receive the microwave transmission data from the at least one microwave sensor and to control the injection apparatus based on the microwave transmission data received from the at least one microwave sensor.

### CROSS REFERENCE TO RELATED APPLICATIONS

This application is a National Stage Entry of PCT/EP 2023/083502 filed on Nov. 29, 2023, which claims priority to EP 22216496.4 filed on Dec. 23, 2022, the entireties of which are hereby incorporated by reference herein for all purposes.

### FIELD

The present invention relates to the field of food processing, in particular in-line food processing. It finds particular application in processing of foodstuff like meat, poultry and fish.

The present invention concerns a food processing line comprising an injection apparatus configured to inject liquid into foodstuff. Additionally, the invention concerns a method for processing foodstuff, in particular meat, poultry or fish, in a food processing line comprising an injection apparatus.

### BACKGROUND

EP 2 708 148 A1 discloses an in-line process for processing meat, wherein a liquid in the form of a brine is injected into the meat. The process involves an injection apparatus that inserts an array of needles into the foodstuff in order to inject the brine into the meat via the needles.

It has however been observed that injection results vary for different types of foodstuffs which are supplied to the injection apparatus. Also, if different qualities of the same type of foodstuff are injected, the results may vary.

Against this background, the problem to be solved is to better control the injection of liquids to varying types and/or qualities of foodstuff.

### SUMMARY

For solving the problem, the invention proposes a food processing line comprising
an injection apparatus configured to inject liquid into foodstuff, and
at least one microwave sensor configured to sense microwave transmission data of the foodstuff, the microwave sensor comprising a microwave transmitter and a microwave receiver that is spaced from the microwave transmitter, the microwave receiver further being configured to receive a transmission signal transmitted by the microwave transmitter, and
a control unit configured to receive the microwave transmission data from the microwave sensor and to control the injection apparatus based on the microwave transmission data received from the microwave sensor.

According to the invention, at least one microwave sensor is provided that is configured to sense microwave transmission data of the foodstuff into which the liquid is injected or is to be injected. This microwave transmission data may be indicative of the quality of the foodstuff under test, in particular indicative of the liquid content of the foodstuff. The microwave transmission data is received by the control unit which is able to control the injection apparatus based on the microwave transmission data. Thus, the invention allows to control the injection apparatus depending on the liquid content of the foodstuff under test. Thereby, controlling the injection of liquids to varying types and/or qualities of foodstuff may be improved or the injection process can be optimized based on trend results.

The liquid to be injected using the injection apparatus may be a brine or a marinade. The liquid may comprise salt and/or spices and/or oil and/or vinegar. The injection apparatus may include one or more injection needles coupled to a liquid reservoir. The microwave transmitter preferably transmits a frequency signal or a narrow bandwidth signal. The single frequency may be a frequency in the range of 0.1 GHz to 10 THz, in particular 810 MHz or 960 MHz or 1.165 GHz. The microwave transmitter preferably works with a transmit power of less than 1 mW, preferably less than 0.5 mW, e.g., 0.1 mW.

According to a preferred embodiment of the invention, the microwave sensor includes a processing unit that is configured to analyze the amplitude of the transmission signal received by the microwave receiver. Analyzing the transmission signal, in particular comparing the amplitude of the signal transmitted by the microwave transmitter and the transmission signal received by the microwave receiver, may indicate an amount of energy absorbed by the foodstuff. It has been found that the amplitude of the transmission signal is well suited for indicating the liquid content of the foodstuff. The processing unit may include a processor, e.g., a programmable processor, and/or a vector network analyzer (VNA). The processing unit may receive the signal transmitted by the microwave transmitter and the transmission signal received by the microwave receiver.

In this context, it is preferred that the processing unit is further configured to analyze a phase of the transmission signal received by the microwave receiver, preferably a phase difference between the signal transmitted by the microwave transmitter and the transmission signal received by the microwave receiver. By analyzing both the amplitude and the phase of the transmission signal the reliability of determining the liquid content can be improved as compared to analyzing only the amplitude.

According to a preferred embodiment of the invention, the control unit is further configured to adjust
a liquid injection pressure based on the microwave transmission data received from the microwave sensor, and/or
a liquid injection volume based on the microwave transmission data received from the microwave sensor, and/or
a speed of an injection head of the injection apparatus based on the microwave transmission data received from the microwave sensor.

Preferably, the foodstuff is situated between the microwave transmitter and the microwave receiver during sensing with the microwave sensor.

According to a preferred embodiment of the invention, the food processing line includes a transport apparatus configured to transport the foodstuff from and/or to the injection apparatus. The microwave sensor(s) is/are preferably arranged at a position along the transport apparatus so as to sense the foodstuff prior to entering the injection apparatus and/or after leaving the injection apparatus. The transport apparatus may be a conveyor, in particular a belt conveyor or a walking beam conveyor.

According to a preferred embodiment of the invention, the transport apparatus is further configured to transport the foodstuff through a gap between the microwave transmitter and the microwave receiver of the microwave sensor. For example, a part of the transport apparatus may be arranged within the gap between the microwave transmitter and the microwave receiver in order to transport the foodstuff through the gap. In this example the transport apparatus may include an essentially horizontal conveyor and the one of the microwave transmitter and the microwave receiver may be arranged above the conveyor whereas the other one of the microwave transmitter and the microwave receiver is arranged below the conveyor so as to form an essentially vertical transmission path. According to an alternative example, both the microwave transmitter and the microwave receiver may be arranged on the same side of the transport apparatus, e.g., on the same side of a conveyor, whereas the transport apparatus does not reach into the gap between the microwave transmitter and the microwave receiver. In this example the transport apparatus may include an essentially horizontal conveyor whereas the microwave transmitter and the microwave receiver form an essentially horizontal transmission path.

According to a preferred embodiment of the invention, the control unit is further configured to control the transport apparatus. In particular, the control unit may be configured to adjust a step displacement of the transport apparatus.

According to a preferred embodiment of the invention, the microwave sensor is arranged upstream the injection apparatus. Arranging the microwave sensor upstream of the injection apparatus allows to sense microwave transmission data of the foodstuff before the liquid being injected into the foodstuff. The liquid content of the foodstuff prior to injection may be indicative of the maximum possible liquid uptake of the foodstuff supplied to the injection apparatus. Thus, measuring the liquid content before liquid injection allows to control the liquid injection in order to achieve maximum liquid uptake in the foodstuff and/or to avoid injection of an amount of liquid which cannot be absorbed by the foodstuff.

According to an alternatively preferred embodiment of the invention, the microwave sensor is arranged downstream the injection apparatus. By arrangement of the microwave sensor downstream the injection apparatus, it is possible to sense microwave transmission data of the foodstuff after the liquid has been injected into the foodstuff. The liquid content of the foodstuff after injection may be indicative of the amount of liquid injected to the foodstuff. Thus, it is possible to check if the liquid uptake has been achieved in the foodstuff and it is possible to adapt liquid injection of following foodstuff, i.e., of the same batch, based on this assessment.

According to a preferred embodiment of the invention, the food processing line comprises at least two microwave sensors, wherein a first microwave sensor is arranged upstream the injection apparatus and a second microwave sensor is arranged downstream the injection apparatus. This embodiment allows to both measure the liquid content of the foodstuff prior to injection and after injection.

According to a preferred embodiment of the invention, the food processing line includes a foodstuff thickness measurement device, in particular comprising a laser or another height measurement device such as a mechanical probe, configured to measure the thickness of the foodstuff, preferably when being situated between the microwave transmitter and the microwave receiver. The control unit is preferably configured to additionally receive the measured thickness of the foodstuff and to control the injection apparatus additionally based on the thickness. In particular, the microwave transmission data may be scaled by the measured thickness. The foodstuff thickness measurement device may be configured to measure a distance between the measurement device and a surface of the foodstuff when the foodstuff is arranged in a known distance to the measurement device, e.g., on a transport apparatus.

According to a preferred embodiment of the invention, the food processing line includes a foodstuff temperature measurement device, in particular comprising an IR temperature sensor, configured to measure the temperature of the foodstuff, in particular the surface temperature of the foodstuff, preferably when being situated in between the microwave transmitter and the microwave receiver. The control unit is preferably configured to additionally receive the measured temperature of the foodstuff and to control the injection apparatus additionally based on the temperature.

According to a preferred embodiment of the invention, the control unit is further configured to
determine a content of certain ingredients of the foodstuff, in particular a fat content of the foodstuff, and/or
log the microwave transmission data received from the microwave sensor, and/or
log data received from the foodstuff thickness measurement device, and/or
log data received from the foodstuff temperature measurement device.

Preferably, the microwave transmission data received from the microwave sensor can be used to determine the chemical ratio of elements. The determined fat content can, e.g., be used to check foodstuff quality and/or to adapt the injection process in the injection apparatus to the foodstuff quality. Logging the above-mentioned data may provide improved insight into the quality of the foodstuff and/or determining a trend and/or storing the data for track and trace reasons. The logged data may optionally be used to optimize the processing, in particular in the injection apparatus, either automatically or manually by an operator of the apparatus.

For solving the problem, the invention further proposes a method for processing foodstuff, in particular meat, poultry or fish, in a food processing line comprising an injection apparatus, at least one microwave sensor and a control unit, wherein
liquid is injected into foodstuff using the injection apparatus,
microwave transmission data of the foodstuff is sensed using the microwave sensor, wherein the microwave sensor comprises a microwave transmitter and a microwave receiver that is spaced from the microwave transmitter, wherein the microwave receiver receives a transmission signal transmitted by the microwave transmitter, and
injecting the liquid using the injection apparatus is controlled by a control unit which receives the microwave transmission data from the microwave sensor based on the microwave transmission data received from the microwave sensor.

The method may achieve the same technical effects and advantages as described in conjunction with the inventive food processing line.

According to a preferred embodiment of the invention, the control unit adjusts
a liquid injection pressure based on the microwave transmission data received from the microwave sensor, and/or
a liquid injection volume based on the microwave transmission data received from the microwave sensor, and/or
a speed of an injection head of the injection apparatus based on the microwave transmission data received from the microwave sensor.

According to a preferred embodiment of the invention, the foodstuff is transported from and/or to the injection apparatus by a transport apparatus, in particular a conveyor, of the food processing line, preferably wherein the transport apparatus transports the foodstuff through a gap between the microwave transmitter and the microwave receiver of the microwave sensor.

According to a preferred embodiment of the invention, the microwave sensor is arranged upstream the injection apparatus and the microwave transmission data of the foodstuff is sensed before the liquid is injected into the foodstuff.

According to an alternatively preferred embodiment of the invention, the microwave sensor is arranged downstream the injection apparatus and the microwave transmission data of the foodstuff is sensed after the liquid has been injected into the foodstuff.

According to a preferred embodiment of the invention, the food processing line comprises at least two microwave sensors, wherein a first microwave sensor is arranged upstream the injection apparatus and senses first microwave transmission data of the foodstuff before the liquid is injected into the foodstuff, wherein a second microwave sensor is arranged downstream the injection apparatus and senses second microwave transmission data of the foodstuff after the liquid has been injected into the foodstuff.

According to a preferred embodiment of the invention, a foodstuff thickness measurement device, in particular comprising a laser or another heigh measurement device such as a mechanical probe, measures the thickness of the foodstuff, preferably when being situated in between the microwave transmitter and the microwave receiver According to a preferred embodiment of the invention, a foodstuff temperature measurement device, in particular comprising an IR temperature sensor, measures the temperature of the foodstuff, in particular the surface temperature of the foodstuff, preferably when being situated in between the microwave transmitter and the microwave receiver.

According to a preferred embodiment of the invention, the control unit further
determines a content of certain ingredients of the foodstuff, in particular a fat content of the foodstuff, and/or
logs the microwave transmission data received from the microwave sensor, and/or
logs data received from the foodstuff thickness measurement device, and/or
logs data received from the foodstuff temperature measurement device.

Preferably, the microwave transmission data received from the microwave sensor can be used to determine the chemical ratio of elements. The determined fat content can, e.g., be used to check foodstuff quality and/or to adapt the injection process in the injection apparatus to the foodstuff quality. Logging the above-mentioned data may provide improved insight into the quality of the foodstuff and/or determining a trend and/or storing the data for track and trace reasons. The logged data may optionally be used to optimize the processing, in particular in the injection apparatus, either automatically or manually by an operator of the apparatus.

Alternatively, or additionally, the beneficial features and/or advantageous embodiments described in conjunction with the food processing line may be implemented in the method for processing foodstuff according to the invention.

These and other characteristics, features and advantages of the present invention will become apparent from the following detailed description, taken in conjunction with the accompanying figures, which illustrates, by way of example, the principles of the invention. The description is given for the sake of example only, without limiting the scope of the invention.

### BRIEF DESCRIPTION OF THE DRAWINGS

FIG. 1 is a schematic representation of a food processing line in accordance with a first embodiment of the invention;

FIG. 2 is a schematic representation of a food processing line in accordance with a second embodiment of the invention;

FIG. 3 is a schematic representation of a food processing line in accordance with a third embodiment of the invention;

FIG. 4 is a schematic representation of a microwave sensor in accordance with a first embodiment;

FIG. 5 is a schematic representation of a microwave sensor in accordance with a second embodiment; and

FIG. 6 is a diagram showing transmission data sensed by a microwave sensor for foodstuff that received no injection, one injection and two injections.

### DETAILED DESCRIPTION

The present invention will be described with respect to embodiments and with reference to the figures, but the invention is not limited thereto but only by the claims. The figures described are only schematic and is non-limiting. In the figures, the size of some of the elements may be exaggerated and not drawn on scale for illustrative purposes.

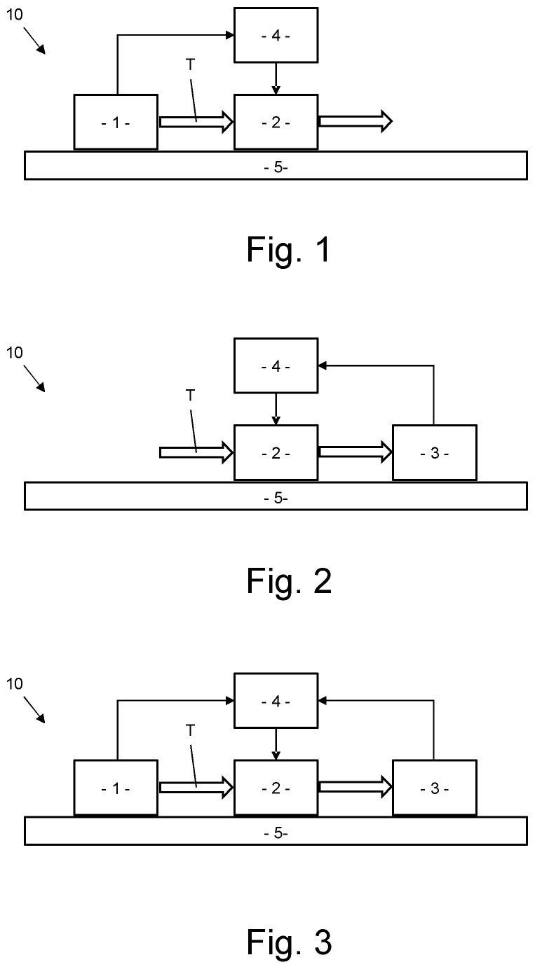

FIG. 1 illustrates a food processing line 10 in accordance with a first embodiment of the invention. The food processing line 10 includes an injection apparatus 2 configured to inject liquid into foodstuff and a control unit 4 connected to the injection apparatus and configured to control the injection apparatus 2. The food processing line further includes a transport apparatus 5 for transporting foodstuff to and from the injection apparatus 2, here for transporting foodstuff in a transport direction T. The transport apparatus 5 may include a conveyor, e.g., a belt conveyor or a walking beam conveyor.

The food processing line 10 further comprises a microwave sensor 1 that is arranged upstream the injection apparatus 2 in the transport direction T of the foodstuff. The microwave sensor 1 is configured to sense microwave transmission data of the foodstuff. The microwave sensor 1 comprises a microwave transmitter and a microwave receiver that is spaced from the microwave transmitter, the microwave receiver further being configured to receive a transmission signal transmitted by the microwave transmitter. The sensed microwave transmission data is sent to the control unit 4 which control unit receives the microwave transmission data from the microwave sensor and to controls the injection apparatus 2 based on the microwave transmission data received from the microwave sensor 1. For example, the control unit 4 may be configured to adjust a liquid injection pressure based on the microwave transmission data received from the microwave sensor 1, and/or a liquid injection volume based on the microwave transmission data received from the microwave sensor 1, and/or a speed of an injection head of the injection apparatus 2 based on the microwave transmission data received from the microwave sensor 1.

FIG. 2 illustrates a food processing line 10 in accordance with a second embodiment of the invention. The second embodiment is similar to the first embodiment. Thus, identical reference numerals are used for elements of identical function and reference is made to the description of the first embodiment. In contrast to the first embodiment, the food processing line of 10 of the second embodiment includes a microwave sensor 3 which is arranged downstream the injection apparatus 2 in the transport direction T of the foodstuff. The microwave sensor 3 The comprises a microwave transmitter and a microwave receiver that is spaced from the microwave transmitter, the microwave receiver further being configured to receive a transmission signal transmitted by the microwave transmitter. The sensed microwave transmission data is sent to the control unit 4 which control unit receives the microwave transmission data from the microwave sensor and to controls the injection apparatus 2 based on the microwave transmission data received from the microwave sensor 3. For example, the control unit 4 may be configured to adjust a liquid injection pressure based on the microwave transmission data received from the microwave sensor 3, and/or a liquid injection volume based on the microwave transmission data received from the microwave sensor 3, and/or a speed of an injection head of the injection apparatus 2 based on the microwave transmission data received from the microwave sensor 3.

FIG. 3 illustrates a food processing line 10 in accordance with a third embodiment of the invention. The third embodiment includes both a first microwave sensor 1 upstream the injection apparatus 2 and a second microwave sensor 3 downstream the injection apparatus 2. The third embodiment combined the aspects of the first and second embodiments. Thus, identical reference numerals are used for elements of identical function and reference is made to the description of the first and second embodiments.

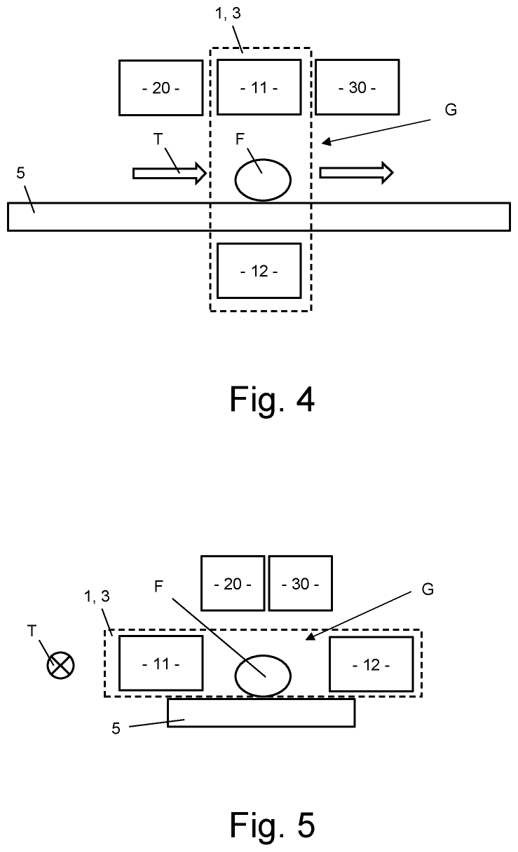

FIG. 4 illustrates a first embodiment of a microwave sensor 1, 3 which can be used on of the embodiments described before. The microwave sensor 1, 3 is arranged at a position along the transport apparatus 5 of the food production line 10. The transport apparatus 5 may be conveyor and is configured to transport the foodstuff F through a gap G between the microwave transmitter 11 and the microwave receiver 12 of the microwave sensor 1, 3. According to the first embodiment the transport direction T the foodstuff F is essentially horizontal. The microwave sensor 1, 3 is configured to comprise a transmission path which is essentially vertical. The microwave transmitter 11 is arranged above the transport apparatus 5 and the microwave receiver 12 is arranged below the transport device 5.

In the region of the microwave sensor 1, 3 also a foodstuff thickness measurement device 20 and a foodstuff temperature measurement device 30 are disposed. Both the foodstuff thickness measurement device 20 and a foodstuff temperature measurement device 30 are configured to measure the respective properties of the foodstuff F when being situated between the microwave transmitter 11 and microwave receiver 12.

The control unit 4 of the food processing line 10 the microwave sensor 1, 3 is used in, is preferably configured to additionally receive the measured thickness of the foodstuff F and to control the injection apparatus 2 additionally based on the thickness. Further, the control unit 3 is preferably configured to additionally receive the measured temperature of the foodstuff F and to control the injection apparatus 2 additionally based on the temperature.

FIG. 5 illustrates a second embodiment of a microwave sensor 1, 3 which can be used on of the embodiments of a food production line described before. The second embodiment of the microwave sensor 1, 3 is similar to the first embodiment as depicted in FIG. 4. Thus, identical reference numerals are used for elements of identical function and reference is made to the description of the first embodiment. In contrast to the first embodiment, the transmission path of the microwave sensor 1, 3 is oriented horizontally. Here, both the microwave transmitter 11 and the microwave receiver 12 are arranged above the transport apparatus 5. The microwave transmitter 11 and the microwave receiver 12 are separated by a gap G, wherein the transport apparatus 5 is configured to transport the foodstuff F through the gap G.

As already described in conjunction with FIG. 4, the second embodiment includes a foodstuff (layer) thickness measurement device 20 and a foodstuff temperature measurement device 30 configured to measure the respective properties of the foodstuff F when being situated in the gap G between the microwave transmitter 11 and microwave receiver 12.

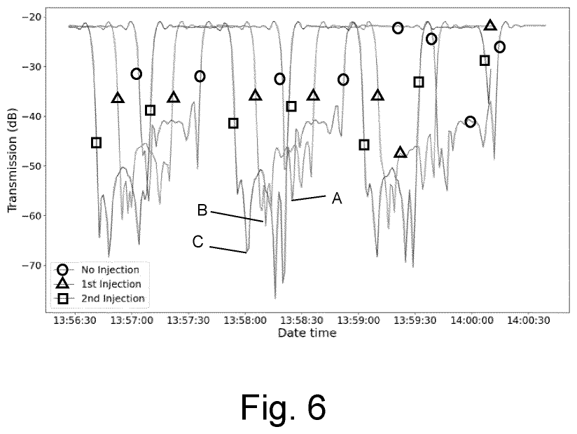

FIG. 6 shows a diagram of transmission data sensed by a microwave sensor for foodstuff that received no injection (curve A with circles), one injection (curve B with triangles) and two injections (curve C with squares). As apparent from the diagram, microwave transmission reduces for increasing liquid content of the foodstuff under test. For example, microwave transmission is reduced for curve B taken for foodstuff that received one injection as compared to curve A taken for foodstuff that received no injection. Similarly, microwave transmission is reduced for curve C taken for foodstuff that received two injections as compared to curve B taken for foodstuff that received one injection.

### LIST OF REFERENCE SIGNS

1 microwave sensor
2 injection apparatus
3 microwave sensor
4 control unit
5 transport apparatus
10 food processing line
11 microwave transmitter
12 microwave receiver
20 foodstuff thickness measurement device
30 foodstuff temperature measurement device
F foodstuff
T transport direction

1. Food processing line comprising:
an injection apparatus configured to inject liquid into foodstuff,
at least one microwave sensor configured to sense microwave transmission data of the foodstuff, the at least one microwave sensor comprising a microwave transmitter and a microwave receiver that is spaced from the microwave transmitter, the microwave receiver configured to receive a transmission signal transmitted by the microwave transmitter, and
a control unit configured to receive the microwave transmission data from the at least one microwave sensor and to control the injection apparatus based on the microwave transmission data received from the at least one microwave sensor.

2. Food processing line according to claim 1, wherein the control unit is further configured to adjust:
a liquid injection pressure based on the microwave transmission data received from the at least one microwave sensor, and/or
a liquid injection volume based on the microwave transmission data received from the at least one microwave sensor, and/or
a speed of an injection head of the injection apparatus based on the microwave transmission data received from the at least one microwave sensor.

3. Food processing line according to claim 1, wherein the food processing line comprise a transport apparatus configured to transport the foodstuff from and/or to the injection apparatus.

4. Food processing line according to claim 3, wherein the transport apparatus is configured to transport the foodstuff through a gap defined between the microwave transmitter and the microwave receiver of the at least one microwave sensor.

5. Food processing line according to claim 3, wherein the control unit is configured to control the transport apparatus or to adjust a step displacement of the transport apparatus.

6. Food processing line according to claim 1, wherein the at least one microwave sensor is arranged upstream of the injection apparatus.

7. Food processing line according to claim 1, wherein the at least one microwave sensor is arranged downstream of the injection apparatus.

8. Food processing line according to claim 1, wherein the food processing line comprises at least two microwave sensors, wherein a first microwave sensor is arranged upstream of the injection apparatus and a second microwave sensor is arranged downstream of the injection apparatus.

9. Food processing line according to claim 1, wherein the food processing line comprises a foodstuff thickness measurement device comprising a laser configured to measure a thickness of the foodstuff when situated between the microwave transmitter and the microwave receiver.

10. Food processing line according to claim 1, wherein the food processing line comprises a foodstuff temperature measurement device comprising an IR temperature sensor configured to measure a temperature of the foodstuff or a surface temperature of the foodstuff when situated in between the microwave transmitter and the microwave receiver.

11. Food processing line according to claim 1, wherein the control unit configured to:
determine a content of certain ingredients of the foodstuff or a fat content of the foodstuff, and/or
log the microwave transmission data received from the at least one microwave sensor, and/or
log data received from a foodstuff thickness measurement device, and/or
log data received from a foodstuff temperature measurement device.

12. Method for processing foodstuff in a food processing line comprising an injection apparatus, at least one microwave sensor, and a control unit, wherein
liquid is injected into the foodstuff using the injection apparatus,
microwave transmission data of the foodstuff is sensed using the at least one microwave sensor, wherein the at least one microwave sensor comprises a microwave transmitter and a microwave receiver that is spaced from the microwave transmitter, wherein the microwave receiver receives a transmission signal transmitted by the microwave transmitter, and
injecting the liquid using the injection apparatus is controlled by a control unit which receives the microwave transmission data from the at least one microwave sensor based on the microwave transmission data received from the at least one microwave sensor.

13. Method according to claim 12, wherein the control unit adjusts:
a liquid injection pressure based on the microwave transmission data received from the at least one microwave sensor, and/or
a liquid injection volume based on the microwave transmission data received from the at least one microwave sensor, and/or
a speed of an injection head of the injection apparatus based on the microwave transmission data received from the at least one microwave sensor.

14. Method according to claim 12, wherein the foodstuff is transported from and/or to the injection apparatus by a transport apparatus of the food processing line, wherein the transport apparatus transports the foodstuff through a gap between the microwave transmitter and the microwave receiver of the at least one microwave sensor.

15. Method according to claim 12, wherein the at least one microwave sensor is arranged upstream of the injection apparatus and the microwave transmission data of the foodstuff is sensed before the liquid is injected into the foodstuff.

16. Method according to claim 13, wherein the at least one microwave sensor is arranged downstream of the injection apparatus and the microwave transmission data of the foodstuff is sensed after the liquid has been injected into the foodstuff.

17. Method according to claim 12, wherein the food processing line comprises at least two microwave sensors, wherein a first microwave sensor is arranged upstream of the injection apparatus and senses first microwave transmission data of the foodstuff before the liquid is injected into the foodstuff, wherein a second microwave sensor is arranged downstream of the injection apparatus and senses second microwave transmission data of the foodstuff after the liquid has been injected into the foodstuff.

18. Method according to claim 12, wherein a foodstuff thickness measurement device comprising a laser measures a thickness of the foodstuff when situated in between the microwave transmitter and the microwave receiver.

19. Method according to claim 12, wherein a foodstuff temperature measurement device comprising an IR temperature sensor measures a temperature of the foodstuff or a surface temperature of the foodstuff when situated in between the microwave transmitter and the microwave receiver.

20. Method according to claim 12, wherein the control unit further:
determines a content of certain ingredients of the foodstuff or a fat content of the foodstuff, and/or
logs the microwave transmission data received from the at least one microwave sensor, and/or
logs data received from a foodstuff thickness measurement device, and/or
logs data received from a foodstuff temperature measurement device.
